(19) United States
(12) Patent Application Publication
(10) Pub. No.: US 2018/0237636 A1
(43) Pub. Date: Aug. 23, 2018

(54) INTERIOR AND EXTERIOR MEMBER FOR AUTOMOBILE

(71) Applicant: MAZDA MOTOR CORPORATION, Hiroshima (JP)

(72) Inventors: Yohei ICHIHARA, Hiroshima-shi, Hiroshima (JP); Haruo SASAKI, Yokkaichi-shi, Mie (JP)

(73) Assignee: MAZDA MOTOR CORPORATION, Hiroshima (JP)

(21) Appl. No.: 15/753,742

(22) PCT Filed: Aug. 5, 2016
(86) PCT No.: PCT/JP2016/003630

§ 371 Date: Feb. 20, 2018

(30) Foreign Application Priority Data
Aug. 26, 2015 (JP) 2015-166734

(51) Int. Cl. C08L 69/00; C08G 64/16

(52) U.S. Cl. CPC C08L 69/00; C08G 64/1608; C08L 2205/025; C08L 2201/08; C08L 2205/03

(57) ABSTRACT

An interior and exterior member for an automobile includes a thermoplastic resin composition including components (A) and (B). The component (A) is a polycarbonate resin mixture including a structural unit derived from a dihydroxy compound and a structural unit derived from cyclohexanedimethanol, wherein the structural unit is in an amount accounting for from 56 mol % to 60 mol % of the total amount of the structural unit and the structural unit derived from cyclohexanedimethanol, and the component (B) is butadiene-butyl acrylate-methyl methacrylate rubber. The thermoplastic resin composition further includes dibutylhydroxytoluene in an amount accounting for from 0.005 parts to 0.015 parts by mass, a benzotriazole-based light resistance stabilizer in an amount accounting for from 0.08 parts to 0.12 parts by mass, and a hindered amine-based light resistance stabilizer in an amount accounting for from 0.04 parts to 0.06 parts by mass, respectively, with respect to 100 parts by mass of the total amount of the components (A) and (B). The component (A) is in an amount accounting for from 93% to 97% by mass of the total amount of the components (A) and (B).

### TECHNICAL FIELD

The present invention relates to an interior and exterior member for an automobile, the interior and exterior member comprised of a thermoplastic resin composition including a polycarbonate resin, a butadiene-butyl acrylate-methyl methacrylate rubber, dibutylhydroxytoluene, a benzotriazole-based light resistance stabilizer, and a hindered amine-based light resistance stabilizer.

### BACKGROUND ART

Aromatic polycarbonate resins have been widely used as engineering plastics having high heat resistance, high impact resistance, and high transparency for various applications in the fields of automobiles, office equipment, and other apparatuses. In general, the aromatic polycarbonate resins are produced using raw materials derived from petroleum resources. Recent apprehension about the depletion of the petroleum resources has created a demand for the provision of plastic moldings made from raw materials derived from biomass resources such as plants. Further, there has been apprehension that the global warming caused by the increase in CO₂ emissions and the accumulation of CO₂ may result in climate change and other adverse phenomena. Therefore, there has been a need for the development of plastic moldings of a plastic which is made from a plant-derived monomer as a raw material and which is carbon neutral when disposed of after use. In particular, the development of such plastic moldings is strongly needed in the field of large moldings.

To address the need, polycarbonate resins of various types including plant-derived monomers as raw materials have been developed.

For example, it has been proposed to produce a polycarbonate resin by using isosorbide as a plant-derived monomer and through transesterification with diphenyl carbonate (e.g., Patent Document 1). Further, a polycarbonate resin produced by copolymerizing isosorbide with bisphenol A has been proposed as a copolymerized polycarbonate of isosorbide and another dihydroxy compound (e.g., Patent Document 2). Furthermore, an attempt has been made to improve the stiffness of a homo-polycarbonate resin made from isosorbide, by copolymerizing isosorbide with aliphatic diol (e.g., Patent Document 3).

Moreover, it has been known that an excellent molding can be produced from a mixture containing at least two selected from polycarbonate resins obtained by copolymerizing isosorbide with a dihydroxy compound and having different composition ratios. The mixture has high flowability and high heat resistance, and the resultant molding is resistant to defects in appearance such as a flow mark such as a tiger mark which may be caused in the injection molding process, and has high impact resistance (Patent Document 4).

In addition, it has been described that a polycarbonate resin composition which includes a polycarbonate resin containing isosorbide and an elastomer comprised of alkyl (meth)acrylate and butadiene and serving as a core layer is highly transparent, highly weather resistant, and highly impact resistant (Patent Documents 5 and 6).

### CITATION LIST

### Patent Documents

Patent Document 1: U.K. Patent No. 1079686

Patent Document 2: Japanese Unexamined Patent Publication No. S56-55425

Patent Document 3: International Publication No. WO 04/111106

Patent Document 4: Japanese Unexamined Patent Publication No. 2014-208800

Patent Document 5: International Publication No. 2012/132492

Patent Document 6: International Publication No. 2012/132493

### SUMMARY OF THE INVENTION

### Technical Problem

However, it is required that an interior and exterior member for an automobile excel in heat resistance and impact strength. Therefore, the moldings described in Patent Documents 4-6 also need to be improved in the heat resistance in order to be used as an interior and exterior member for an automobile.

Thus, it is an object of the present invention to solve the problems of the known art described above, and to provide a highly weather-resistant interior and exterior member for an automobile.

### Solution to the Problem

The present inventors have conducted studies and made the present invention based on the following findings: the problems above described can be solved by a thermoplastic resin composition including: a polycarbonate resin mixture produced by melting and mixing a plurality of polycarbonate copolymers each containing a specific structural unit derived from a dihydroxy compound and having different copolymerization ratios; a butadiene-butyl acrylate-methyl methacrylate rubber; dibutylhydroxytoluene; a benzotriazole-based light resistance stabilizer; and a hindered amine-based light resistance stabilizer.

Specifically, the present invention includes the following feature as the gist.

An interior and exterior member for an automobile includes a thermoplastic resin composition including components (A) to (E). The component (C) is in an amount accounting for from 0.005 parts to 0.015 parts by mass, the component (D) is an amount accounting for from 0.08 parts to 0.12 parts by mass, and the component (E) is in an amount accounting for from 0.04 part to 0.06 parts by mass, respectively, with respect to 100 parts by mass of a total amount of the components (A) and (B), and the component (A) is in an amount accounting for from 93% to 97% by mass of the total amount of the components (A) and (B).

The component (A) is a polycarbonate resin mixture produced by melting and mixing a plurality of carbonate copolymers each including a structural unit derived from a dihydroxy compound represented by the following general formula (1) and a structural unit derived from cyclohexanedimethanol, the plurality of carbonate copolymers having different copolymerization ratios, wherein the structural unit derived from the dihydroxy compound represented by the general formula (1) is in an amount accounting for from 56 mol % to 60 mol % of a total amount of the structural unit derived from the dihydroxy compound represented by the general formula (1) and the structural unit derived from cyclohexanedimethanol.

The component (B) is butadiene-butyl acrylatemethyl-methacrylate rubber.

The component (C) is dibutylhydroxytoluene.

The component (D) is a benzotriazole-based light resistance stabilizer.

The component (E) is a hindered amine-based light resistance stabilizer.

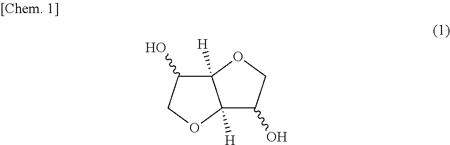

[2] The interior and exterior member according to [1] above, wherein the hindered amine-based light resistance stabilizer has a piperidine structure.

[3] The interior and exterior member according to [2] above, wherein the hindered amine-based light resistance stabilizer has the piperidine structure comprising a plurality of piperidine structures.

[4] The interior and exterior member according to [3] above, wherein the plurality of piperidine structures of the hindered amine-based light resistance stabilizer are linked with each other via an ester linkage.

[5] The interior and exterior member according to any one of [1] to [4] above, wherein the interior and exterior member is produced by injection molding.

### Advantages of the Invention

The present invention, according to which a specific thermoplastic resin composition is used, provides a highly weather-resistant interior and exterior member for an automobile.

### DESCRIPTION OF EMBODIMENTS

Embodiments of the present invention will now be described in detail. Note that the present invention is not limited to the following embodiments, but can be worked with various modifications made thereto, without departure from the gist of the present invention.

The present invention relates to an interior and exterior member for an automobile, the interior and exterior member comprised of a thermoplastic resin composition containing predetermined amounts of specific components.

### [Thermoplastic Resin Composition]

The thermoplastic resin composition includes: a predetermined amount of a specific polycarbonate resin mixture (Component (A)); a predetermined amount of a butadiene-butyl acrylate-methyl methacrylate rubber (hereinafter referred to also as “the butadiene rubber”; Component (B)); a predetermined amount of dibutylhydroxytoluene (Component (C)); a predetermined amount of a benzotriazole-based light resistance stabilizer (Component (D)); and a predetermined amount of a hindered amine-based light resistance stabilizer (Component (E)).

### [Component (A) (Polycarbonate Resin Mixture)]

The polycarbonate resin mixture, i.e., the Component (A), is a mixture of a plurality of polycarbonate resins.

Each of the plurality of polycarbonate resins is a carbonate copolymer obtained through polymerization using at least both a dihydroxy compound represented by the general formula (1) shown below as a dihydroxy compound, and cyclohexanedimethanol. The carbonate copolymer has at least both a structural unit (hereinafter referred to also as the “structural unit (1)”) derived from the dihydroxy compound represented by the general formula (1) shown below and a structural unit derived from cyclohexanedimethanol.

The Component (A) is a mixture obtained by melting and mixing a plurality of carbonate copolymers having different copolymerization ratios of the above polyol components, specifically different copolymerization ratios between the structural unit (1) and the structural unit derived from cyclohexanedimethanol.

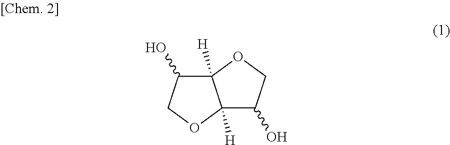

### <Dihydroxy Compounds Having a Part Represented by Formula (1)>

Examples of the dihydroxy compounds represented by Formula (1) above include isosorbide, isomannide, and isoidet which are in a stereoisomeric relationship.

One kind of these dihydroxy compounds represented by Formula (1) above may be used alone, or two or more kinds thereof may be used in combination.

In view of availability, ease in production, optical properties, and moldability, isosorbide is the most preferable of these dihydroxy compounds represented by Formula (1). Isosorbide exists as an abundant resource, is easy to obtain, and can be produced through dehydration and condensation of sorbitol made from various starches.

### <Cyclohexanedimethanol>

Specific examples of the cyclohexanedimethanol described above include 1,2-cyclohexanedimethanol, 1,3-cyclohexanedimethanol, and 1,4-cyclohexanedimethanol.

### <Diester Carbonate>

The polycarbonate resin described above can be produced by generally-used polymerization methods including an interfacial polymerization method involving use of phosgene, and a melt polymerization method involving a transesterification reaction with a diester carbonate, either of which may be used. However, it is preferable to use the melt polymerization method, in which a transesterification reaction is caused between the dihydroxy compound and a diester carbonate that is less environmentally toxic, in the presence of a polymerization catalyst.

In that case, the polycarbonate resin can be obtained by the melt polymerization method, in which the transesterification reaction is caused between the diester carbonate and the dihydroxy compound that includes at least both the dihydroxy compound represented by the general formula (1) shown above and cyclohexanedimethanol.

Among some usable diester carbonates, one represented by Formula (2) shown below is used usually. One kind of the diester carbonates may be used alone, or two or more kinds thereof may be used in combination.

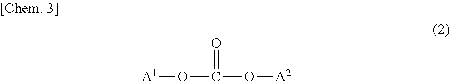

In Formula (2) shown above, A¹ and A² are independently substituted or unsubstituted aliphatic groups having 1 to 18 carbons, or substituted or unsubstituted aromatic groups.

Non-limiting examples of the diester carbonates represented by Formula (2) above include substituted diphenyl carbonates such as diphenyl carbonate and ditolyl carbonate, dimethyl carbonate, diethyl carbonate, and di-t-butyl carbonate. Among them, substituted diphenyl carbonates including diphenyl carbonate are preferable, and diphenyl carbonate is particularly preferable. Note that a diester carbonate may include impurities such as chloride ions. The impurities may inhibit the polymerization reaction, or deteriorate the hue of the obtained polycarbonate resin. It is therefore preferable to use a diester carbonate purified by, for example, distillation, as necessary.

The diester carbonate is used, with respect to all dihydroxy compounds used for the melt polymerization, in a molar ratio preferably from 0.90 to 1.20, more preferably from 0.95 to 1.10, still more preferably from 0.96 to 1.10, and particularly preferably from 0.98 to 1.04.

If the molar ratio is less than 0.90, a terminal hydroxyl group of the produced polycarbonate resin increases to deteriorate the thermal stability of the polymer. As a result, coloration may be caused during the molding process of the thermoplastic resin composition, the speed of the transesterification reaction may be slowed, or it becomes impossible to obtain a desired high molecular weight member resin.

If the molar ratio is greater than 1.20, the speed of the transesterification reaction is slowed under the same condition, and it becomes difficult to produce a polycarbonate resin having a desired molecular weight. In addition, the produced polycarbonate resin contains an increased amount of the residual diester carbonate, which may adversely cause an odor during the molding process or of the produced molding. The residual diester carbonate may increase thermal hysteresis during the polymerization reaction, and consequently, may deteriorate the hue and the weather resistance of the obtained polycarbonate resin.

Furthermore, an increase in the molar ratio of the diester carbonate with respect to all dihydroxy compounds results in an increase in the amount of the residual diester carbonate in the obtained polycarbonate resin. The residual diester carbonate absorbs ultraviolet radiation and may deteriorate the light resistance of the polycarbonate resin. The diester carbonate remains in the polycarbonate resin of the present invention at a concentration of preferably 200 ppm by mass or less, more preferably 100 ppm by mass or less, still more preferably 60 ppm by mass or less, and yet more preferably 30 ppm by mass or less. However, a polycarbonate resin may actually include an unreacted diester carbonate. The lower limit of the concentration of an unreacted diester carbonate in a polycarbonate resin is usually 1 ppm by mass.

### <Transesterification Reaction Catalyst>

As described previously, the polycarbonate resin of the present invention can be produced through the transesterification reaction between the dihydroxy compound including the dihydroxy compound (1) and the diester carbonate represented by Formula (2) shown above. More specifically, the polycarbonate resin of the present invention can be produced by causing the transesterification reaction and removing by-products such as a monohydroxy compound outside the system. In this case, the melt polymerization is usually carried out through the transesterification reaction in the presence of a transesterification reaction catalyst.

Examples of the transesterification reaction catalyst (hereinafter referred to also as “the catalyst”) useable for the production of the polycarbonate resin of the present invention include, for example, a metal compound of Group 1 or Group 2 specified in the long-form periodic table (Nomenclature of Inorganic Chemistry IUPAC Recommendations 2005) (hereinafter simply referred to as “Group 1” and “Group 2”), and basic compounds such as a basic boron compound, a basic phosphorus compound, a basic ammonium compound, and an amine-based compound. Among these compounds, the metal compound of Group 1 and/or the metal compound of Group 2 are preferably used.

It is possible to use the basic compounds such as a basic boron compound, a basic phosphorus compound, a basic ammonium compound, and an amine-based compound in an auxiliary manner, in combination with the metal compound of Group 1 and/or the metal compound of Group 2. However, it is particularly preferable to use the metal compound of Group 1 and/or the metal compound of Group 2 alone.

The metal compound of Group 1 and/or the metal compound of Group 2 may be used usually in the form of a hydroxide or in the form of salts such as carbonate, carboxylate, and phenolate. In view of availability and ease in handling, the forms of a hydroxide, a carbonate, and an acetate are preferable. To improve the hue and the polymerization activity, the form of an acetate is preferable.

Examples of the metal compounds of Group 1 include sodium hydroxide, potassium hydroxide, lithium hydroxide, cesium hydroxide, sodium hydrogencarbonate, potassium hydrogencarbonate, lithium hydrogencarbonate, cesium hydrogencarbonate, sodium carbonate, potassium carbonate, lithium carbonate, cesium carbonate, sodium acetate, potassium acetate, lithium acetate, cesium acetate, sodium stearate, potassium stearate, lithium stearate, cesium stearate, sodium borohydride, potassium borohydride, lithium borohydride, cesium borohydride, sodium borophenylate, potassium borophenylate, lithium borophenylate, cesium borophenylate, sodium benzoate, potassium benzoate, lithium benzoate, cesium benzoate, disodium hydrogenphosphate, dipotassium hydrogenphosphate, dilithium hydrogenphosphate, dicesium hydrogenphosphate, disodium phenylphosphate, dipotassium phenylphosphate, dilithium phenylphosphate, dicesium phenylphosphate, alcoholates and/or phenolates of sodium, potassium, lithium and cesium, and disodium salt, dipotassium salt, dilithium salt, and dicesium salt of bisphenol A. Among them, the cesium compounds and the lithium compounds are preferable.

Examples of the metal compounds of Group 2 include calcium hydroxide, barium hydroxide, magnesium hydroxide, strontium hydroxide, calcium hydrogencarbonate, barium hydrogencarbonate, magnesium hydrogencarbonate, strontium hydrogencarbonate, calcium carbonate, barium carbonate, magnesium carbonate, strontium carbonate, calcium acetate, barium acetate, magnesium acetate, strontium acetate, calcium stearate, barium stearate, magnesium stearate, and strontium stearate. Among them, the magnesium compounds, the calcium compounds, and the barium compounds are preferable, and the magnesium compounds and/or the calcium compounds are more preferable.

Examples of the basic boron compound include sodium salts, potassium salts, lithium salts, calcium salts, barium salts, magnesium salts and strontium salts of tetramethylboron, tetraethylboron, tetrapropylboron, tetrabutylboron, trimethylethylboron, trimethylbenzylboron, trimethylphenylboron, triethylmethylboron, triethylbenzylboron, triethylphenylboron, tributylbenzylboron, tributylphenylboron, tetraphenylboron, benzyltriphenylboron, methyltriphenylboron, and butyltriphenylboron.

Examples of the basic phosphorus compound include triethylphosphine, tri-n-propylphosphine, triisopropylphosphine, tri-n-butylphosphine, triphenylphosphine, tributylphosphine, and a quaternary phosphonium salt.

Examples of the basic ammonium compound include tetramethylammonium hydroxide, tetraethylammonium hydroxide, tetrapropylammonium hydroxide, tetrabutylammonium hydroxide, trimethylethylammonium hydroxide, trimethylbenzylammonium hydroxide, trimethylphenylammonium hydroxide, triethylmethylammonium hydroxide, triethylbenzylammonium hydroxide, triethylphenylammonium hydroxide, tributylbenzylammonium hydroxide, tributylphenylammonium hydroxide, tetraphenylammonium hydroxide, benzyltriphenylammonium hydroxide, methyltriphenylammonium hydroxide, and butyltriphenylammonium hydroxide.

Examples of the amine-based compound include 4-aminopyridine, 2-aminopyridine, N,N-dimethyl-4-aminopyridine, 4-diethylaminopyridine, 2-hydroxypyridine, 2-methoxypyridine, 4-methoxypyridine, 2-dimethylaminoimidazole, 2-methoxyimidazole, imidazole, 2-mercaptoimidazole, 2-methylimidazole, and aminoquinoline.

To make the obtained polycarbonate resin excellent in various properties such as the transparency, hue, and light resistance, it is preferable to use, as the catalyst, at least one metal compound selected from the group consisting of the metal compounds of Group 2 and the lithium compounds.

To allow the polycarbonate resin to be particularly excellent in the transparency, hue, and light resistance, the catalyst is preferably comprised of at least one metal compound selected from the group consisting of the magnesium compounds, the calcium compounds, and the barium compounds, and is more preferably comprised of at least one metal compound selected from the group consisting of the magnesium compounds and the calcium compounds.

If the catalyst is comprised of the metal compound of Group 1 and/or the metal compound of Group 2, the amount of the catalyst to be used, in terms of a metal equivalent, ranges preferably from 0.1 μmol to 300 μmol, more preferably from 0.1 μmol to 100 μmol, still more preferably from 0.5 μmol to 50 μmol, and still yet more preferably from 1 μmol to 25 μmol, with respect to 1 mol of all dihydroxy compounds to be subjected to the reaction.

If a compound including at least one metal selected from the group consisting of the metals of Group 2 is used as the catalyst, the amount to be used is, in terms of a metal equivalent, preferably 0.1 μmol or more, more preferably from 0.5 μmol or more, and particularly preferably 0.7 μmol or more, with respect to 1 mol of all dihydroxy compounds to be subjected to the reaction. The upper limit of the amount is preferably 20 μmol, more preferably 10 μmol, particularly preferably 3 μmol, and most preferably 2.0 μmol.

An excessively small amount of the catalyst used makes it impossible to achieve the polymerization activity required for producing a polycarbonate resin having a desired molecular weight, which may result in obtainment of insufficient fracture energy. On the other hand, an excessively large amount of the catalyst used not only deteriorates the hue of the obtained polycarbonate resin, but also produces by-products which reduce the flowability or increase generation of gels. This may cause brittle fracture, and make it difficult to produce a polycarbonate resin of desired quality.

### <Method for Producing Polycarbonate Resin>

The polycarbonate resin described above can be produced by the transesterification between, and the melt polymerization of, a diester carbonate and a dihydroxy compound including the dihydroxy compound represented by the general formula (1) shown above and cyclohexanedimethanol. It is preferable to uniformly mix the materials, i.e., the dihydroxy compound and the diester carbonate, together before the transesterification reaction.

The mixing of the materials is carried out at a temperature of usually 80° C. or more, and preferably 90° C. or more. The upper limit of the temperature is usually 250° C. or less, preferably 200° C. or less, and still more preferably 150° C. or less. It is particularly favorable to carry out the mixing at a temperature ranging from 100° C. to 120° C. Mixing carried out at an excessively low temperature may slow the dissolution speed or cause insufficient solubility, and often result in inconvenience such as solidification. Mixing carried out at an excessively high temperature may cause thermal degradation of the dihydroxy compound, and as result, may deteriorate the hue of the obtained polycarbonate resin and adversely affect its light resistance.

In order to prevent the deterioration of the hue of the obtained polycarbonate resin, the operation to mix the dihydroxy compound and the diester carbonate is performed in an atmosphere having an oxygen concentration of 10% by volume or less, more preferably from 0.0001% to 10% by volume, still more preferably from 0.0001% to 5% by volume, and particularly preferably from 0.0001% to 1% by volume.

In one preferred embodiment, the polycarbonate resin is produced through multi-stage melt polymerization using the catalyst and a plurality of reactors. The melt polymerization is performed in the plurality of reactors because: in early stages of the melt polymerization, since the reaction mixture contains a large amount of a monomer, it is important to reduce vaporization of the monomer while maintaining a necessary speed of polymerization; whereas in latter stages of the melt polymerization, it is important to sufficiently evaporate a by-product monohydroxy compound out, in order to cause the equilibrium to shift to the polymerization. In order to improve the production efficiency, it is preferable to set such different conditions of the polymerization reaction through the use of multiple reactors connected in series. As described previously, it is suitable to use at least two reactors. However, to improve the production efficiency, at least three reactors, preferably three to five reactors, and particularly preferably four reactors are used.

The mode of reaction may be any of a batch mode, a continuous mode, or a combination thereof.

Further, it is effective to use a reflux condenser in the polymerization reactor for the purpose of reducing the amount of monomer to be distilled out. In particular, it is significantly effective to employ such a reflux condenser in the reactor for the early stages of the polymerization in which a large amount of an unreacted monomer component is present. The temperature of a refrigerant to be introduced into the reflux condenser may be set selectively and appropriately in accordance with the monomer to be used. However, the refrigerant to be introduced into the reflux condenser has, at an inlet of the reflux condenser, a temperature ranging usually from 45° C. to 180° C., preferably from 80° C. to 150° C., and particularly preferably from 100° C. to 130° C. If the refrigerant to be introduced into the reflux condenser has an excessively high temperature, the reflux amount decreases, and the effect of the reflux condenser tends to decrease. If the refrigerant to be introduced into the reflux condenser has an excessively low temperature, an efficiency at which the monohydroxy compound to be properly removed is evaporated out tends to decrease. Examples of the refrigerant include warm water, vapor, and heat transfer oil. Vapor or heat transfer oil is preferable.

Choice of the amount and kind of the catalyst described above is important for preventing the deterioration of the hue, the thermal stability, and the light resistance of the finally produced polycarbonate resin, and at the same time, for maintaining an appropriate polymerization speed and reducing the distilling-out of the monomer.

If the number of the reactors is two or more, the production of the polycarbonate resin described above may be carried out such that multiple reaction stages of different conditions are further performed in each reactor or the temperature and pressure inside each reactor are varied continuously, for example.

For the production of the polycarbonate resin, the catalyst may be added to a feed preparation tank or a feed reservoir. Alternatively, the catalyst may be added directly to the reactor. To stabilize the supply of the catalyst and control the melt polymerization, it is preferable to provide a catalyst supply line at an intermediate portion of a raw material line upstream of the reactors and to supply the catalyst in the form of an aqueous solution from the catalyst supply line.

The polymerization conditions are preferably set such that in the early stages of the polymerization, a prepolymer is obtained at a relatively low temperature and in a low vacuum, and in the latter stages of the polymerization, the molecular weight is increased to a desired value at a relatively high temperature and in a high vacuum. However, in view of the hue and light resistance of the obtained polycarbonate resin, it is important to appropriately set a jacket temperature and an inner temperature in each molecular weight stage and a pressure in the reaction system. For example, if at least one of the temperature or the pressure is varied too early before the polymerization reaction reaches a predetermined value, an unreacted monomer is distilled out and the molar ratio between the dihydroxy compound and the diester carbonate is varied adversely, causing a decrease in the polymerization speed or rendering it impossible to obtain a polymer having a predetermined molecular weight and a predetermined terminal group. As a result, the object of the present invention cannot be achieved.

If the transesterification reaction occurs at an excessively low temperature, the productivity decreases and the thermal hysteresis of the product increases. If the transesterification reaction occurs at an excessively high temperature, the monomer vaporizes, and additionally, decomposition and coloration of the polycarbonate resin may be facilitated.

To produce the polycarbonate resin described above, the method of causing transesterification reaction between the diester carbonate and the dihydroxy compound including the dihydroxy compound represented by the general formula (1) shown above and cyclohexanedimethanol in the presence of the catalyst is usually performed by a multistage process consisting of two or more stages. Specifically, a transesterification reaction temperature in a first stage (hereinafter referred to also as “the inner temperature”) is preferably 140° C. or more, more preferably 150° C. or more, still more preferably 180° C. or more, and yet still more preferably 200° C. or more. The transesterification reaction temperature in the first stage is preferably 270° C. or less, more preferably 240° C. or less, still more preferably 230° C. or less, and yet still more preferably 220° C. or less. A residence time in the transesterification reaction in the first stage ranges usually from 0.1 to 10 hours, preferably from 0.5 to 3 hours. The transesterification reaction in the first stage is performed while the generated monohydroxy compound is evaporated out of the reaction system. In the second and subsequent stages, the transesterification reaction temperature is raised such that the transesterification reaction is allowed to take place at a temperature usually from 210° C. to 270° C., and preferably from 220° C. to 250° C. While the monohydroxy compound generated at the same time is removed from the reaction system, the pressure of the reaction system is reduced gradually from the value of the first stage. Thus, until the pressure of the reaction system eventually decreases to 200 Pa or less, a polycondensation reaction is allowed to continue for a duration of usually from 0.1 to 10 hours, preferably from 0.5 to 6 hours, and particularly preferably from 1 to 3 hours.

If the transesterification reaction temperature is excessively high, the resultant molding may have deteriorated hue and become liable to brittle fracture. If the transesterification reaction temperature is excessively low, the molecular weight may not increase to reach a target value, molecular weight distribution may widen, and an insufficient impact strength may be obtained. If the residence time of the transesterification reaction is excessively long, the resultant molding may become liable to brittle fracture. If the residence time is excessively short, the molecular weight may not increase to reach the target value, and an insufficient impact strength may be obtained.

To effectively utilize resources, the by-product monohydroxy compound is preferably reused, after being subjected to purification as necessary, as a material for a diester carbonate or various bisphenol compounds.

In particular, to obtain a favorable polycarbonate resin having a high impact strength while reducing the coloration, thermal degradation, or burn marks of the polycarbonate resin, the upper limit of the inner temperature of the reactors in all of the reaction stages is set to preferably less than 255° C., more preferably less than 250° C., and particularly preferably from 225° C. to 245° C. To reduce a decrease in the polymerization speed in the latter stages of the polymerization reaction and to minimize the thermal degradation of the polycarbonate resin due to the thermal hysteresis, it is preferable to use a horizontal reactor which has a high plug flowability and a high interface renewal performance in a final stage of the reaction.

In some cases, the polymerization temperature is raised as high as possible and the polymerization time is prolonged for the purpose of producing a polycarbonate resin having a high molecular weight and a high impact strength. In such cases, the resultant polycarbonate resin tends to include unwanted by-products or have burn marks, and become liable to brittle fracture. Therefore, to produce a polycarbonate resin which has a high impact strength, and at the same time, is less liable to brittle fracture, it is preferable that the polymerization temperature be kept low, a highly active catalyst be used to shorten the polymerization time, and adjustments such as proper setting of the pressure of the reaction system be made. In addition, to make the polycarbonate resin less liable to brittle fracture, it is preferable to remove unwanted by-products and burn marks generated in the reaction system by using a filter or other means in the middle or the final stage of the reaction.

In a case where a polycarbonate resin is produced using a substituted diphenyl carbonate such as diphenyl carbonate and ditolyl carbonate as the diester carbonate represented by the above Formula (2), by-product phenol and by-product substituted phenol unavoidably remain in the polycarbonate resin. The phenol and substituted phenol, which have an aromatic ring, absorb ultraviolet radiation and may become a factor not only of deterioration of the light resistance, but also of generation of an odor during the molding process. After a usual batch reaction, a polycarbonate resin contains at least 1000 ppm by mass of aromatic monohydroxy compounds having an aromatic ring, such as by-product phenol. In view of the light resistance and odor reduction, it is preferable to reduce, using a horizontal reactor with high vaporization properties or an extruder with a vacuum vent, the content of the aromatic monohydroxy compounds contained in a polycarbonate resin preferably to 700 ppm by mass or less, more preferably 500 ppm by mass or less, and particularly preferably 300 ppm by mass. However, it is industrially difficult to completely remove the aromatic monohydroxy compounds, and the lower limit of the content of the aromatic monohydroxy compounds contained in a polycarbonate resin is usually 1 ppm by mass. Note that these aromatic monohydroxy compounds may naturally have a substituent, depending on the row material used. For example, these aromatic monohydroxy compounds may have an alkyl group having 5 or less carbons.

The metals of Group 1, specifically lithium, sodium, potassium, and cesium, in particular, sodium, potassium, and cesium may enter a polycarbonate resin, not only from the catalyst used, but also from the raw material and the reaction apparatus. If a large amount of these metals is contained in a polycarbonate resin, the hue of the polycarbonate resin may be affected adversely. It is therefore preferable that the polycarbonate resin of the present invention include a small total content of these compounds. Specifically, the total content in terms of a metal content in the polycarbonate resin is usually 1 ppm by mass or less, preferably 0.8 ppm by mass or less, and more preferably 0.7 ppm by mass or less.

A metal content in a polycarbonate resin can be measured by various known methods. For example, the metals contained in a polycarbonate resin are collected by wet ashing or other methods, and then, the collected metals may be measured by atomic emission spectroscopy, atomic absorption spectrometry, Inductively Coupled Plasma (ICP), or other methods.

After the melt polymerization described above, the polycarbonate resin of the present invention is usually cooled and solidified, and pelletized by a rotary cutter or other devices.

Examples of the pelletizing method include, but are not limited to: a method in which the polycarbonate resin in a melted state is taken out from a final polymerization reactor, cooled and solidified in the shape of a strand, and then pelletized; a method in which the polycarbonate resin in a melted state is supplied from a final polymerization reactor to a single- or double-shaft extruder, subjected to melt extrusion, and cooled and solidified to be pelletized; and a method in which the polycarbonate resin in a melted state is taken out from a final polymerization reactor, cooled and solidified in the shape of a strand, and then once pelletized, thereafter, the resin is supplied again to a single- or double-shaft extruder, subjected to melt extrusion, and cooled and solidified to be pelletized.

When the above methods are implemented, the residual monomer can be evaporated under reduced pressure in the extruder. Alternatively, at least one of commonly known additives such as a thermal stabilizer, a neutralizing agent, a UV absorber, a mold release agent, a coloring agent, an anti-static agent, an internal lubricant, an external lubricant, a plasticizer, a compatibilizer, and a fire retardant may be added and kneaded in the extruder.

The temperature for melt kneading in the extruder depends on the glass-transition temperature and molecular weight of the polycarbonate resin. The temperature for melt kneading ranges usually from 150° C. to 300° C., preferably from 200° C. to 270° C., and more preferably 230° C. to 260° C. If the temperature for melt kneading is lower than 150° C., the polycarbonate resin has a high melt viscosity to apply a large load on the extruder, resulting in a decrease in the productivity. If the temperature for melt kneading is higher than 300° C., the polycarbonate resin suffers severe thermal degradation, resulting in not only a decrease in the mechanical strength due to a decrease in the molecular weight, but also coloration, and generation of gas, unwanted by-products, and burn marks. A filter for removing the unwanted by-products and the burn marks is preferably provided inside or at the outlet of the extruder.

To achieve a filtering accuracy to remove at least 99% of unwanted by-products, the filter has a size (i.e., a mesh size), for removing unwanted by-products, of usually 400 μm or less, preferably 200 μm or less, and particularly preferably 100 μm or less. If the mesh size of the filter is excessively large, some of the unwanted by-products and burn marks may pass through the filter, and the polycarbonate resin may suffer brittle fracture when being molded. The mesh size of the filter can be adjusted according to the applications of the thermoplastic resin composition of the present invention. For example, if the thermoplastic resin composition of the present invention is used as a film, the mesh size of the filter is preferably 40 μm or less and more preferably 10 μm or less since the film is required to be free of defects.

Further, two or more filters may be arranged in series. Alternatively, a filtering device comprised of a stack of a plurality of leaf disk type polymer filters may be used.

It is preferable to use a cooling method such as an air cooling method or a water cooling method to cool the melt-extruded polycarbonate resin for pelletizing. It is preferable that the air cooling is performed using air from which foreign substances have been removed in advance by, for example, a HEPA filter (preferably a filter specified in JIS Z8112) such that the foreign substances are prevented from adhering to the polycarbonate resin. The air cooling is performed in a clean room whose cleanliness preferably exceeds cleanliness class 7, and more preferably exceeds cleanliness class 6, the cleanliness classes defined in JIS B9920 (2002). If water cooling is employed, it is preferable to use water from which the metal components contained therein have been removed using, for example, an ion-exchange resin, and from which foreign substances contained therein have been removed using a filter. Although filters having different mesh sizes may be used for the water cooling, it is preferable to use a filter having a mesh size ranging from 10 μm to 0.45 μm.

When the polycarbonate resin of the present invention is produced by melt polymerization, in order to prevent coloration, one member or two or more members of phosphate compound and phosphite compound can be added during the polymerization.

As the phosphate compound, one member or two or more members of trialkyl phosphates such as trimethyl phosphate and triethyl phosphate are suitably used. Such a phosphate compound is added in a ratio preferably from 0.0001 mol % to 0.005 mol %, and more preferably from 0.0003 mol % to 0.003 mol %, with respect to all hydroxy compounds to be subjected to the reaction. If the amount of the phosphate compound added is less than the lower limit above, the effect of preventing the coloration may be small, whereas if the amount added exceeds the upper limit, this may deteriorate the transparency, or conversely facilitate the coloration, or reduce the heat resistance.

As the phosphite compound, any of the following thermal stabilizers may be selectively used. In particular, one member or two or more members of trimethyl phosphite, triethyl phosphite, trisnonylphenyl phosphite, trimethyl phosphate, tris(2,4-di-tert-butylphenyl)phosphite, and bis(2,4-di-tert-butylphenyl)pentaerythritol diphosphite can be suitably used. Such a phosphite compound is added in a ratio preferably from 0.0001 mol % to 0.005 mol %, more preferably from 0.0003 mol % to 0.003 mol %, with respect to all hydroxy compounds to be subjected to the reaction. If the amount of the phosphite compound added is less than the lower limit above, the effect of preventing coloration may be small, whereas if the amount added exceeds the upper limit, this may deteriorate the transparency, or conversely facilitate the coloration, or reduce the heat resistance.

The phosphate compound and the phosphite compound may be added in combination. In this case, the phosphate compound and the phosphite compound are added, in total, in a ratio preferably from 0.0001 mol % to 0.005 mol %, and more preferably 0.0003 mol % to 0.003 mol %, with respect to all hydroxy compounds to be subjected to the reaction. If the amount added is less than the lower limit above, the effect of preventing coloration may be small, whereas if the amount added exceeds the upper limit, this may deteriorate the transparency, or conversely facilitate the coloration, or reduce the heat resistance.

The polycarbonate resin produced in the manner above may contain one type or two or more types of thermal stabilizers for the purpose of preventing a decrease in the molecular weight and deterioration of the hue during, for example, the molding process.

Examples of the thermal stabilizers include a phosphorous acid, a phosphoric acid, a phosphonous acid, a phosphonic acid, and esters thereof. Specific examples thereof include triphenyl phosphite, tris(nonylphenyl)phosphite, tris(2,4-di-tert-butylphenyl)phosphite, tridecyl phosphite, trioctyl phosphite, trioctadecyl phosphite, didecylmonophenyl phosphite, dioctylmonophenyl phosphite, diisopropylmonophenyl phosphite, monobutyldiphenyl phosphite, monodecyldiphenyl phosphite, monooctyldiphenyl phosphite, bis(2,6-di-tert-butyl-4-methylphenyl)pentaerythritol diphosphite, 2,2-methylenebis(4,6-di-tert-butylphenyl)octyl phosphite, bis(nonylphenyl)pentaerythritol diphosphite, bis(2,4-di-tert-butylphenyl)pentaerythritol diphosphite, distearylpentaerythritol diphosphite, tributyl phosphate, triethyl phosphate, trimethyl phosphate, triphenyl phosphate, diphenylmonoorthoxenyl phosphate, dibutyl phosphate, dioctyl phosphate, diisopropyl phosphate, tetrakis(2,4-di-tert-butylphenyl) 4,4′-biphenylenediphosphinate, dimethyl benzenephosphonate, diethyl benzenephosphonate, and dipropyl benzenephosphonate. Among these, trisnonylphenyl phosphite, trimethyl phosphate, tris(2,4-di-tert-butylphenyl)phosphite, bis(2,4-di-tert-butylphenyl)pentaerythritol diphosphite, bis(2,6-di-tert-butyl-4-methylphenyl)pentaerythritol diphosphite, and dimethyl benzenephosphonate are preferably used.

The thermal stabilizer may be further additionally blended, in addition to the amount added at the melt polymerization. Specifically, following the obtainment of a polycarbonate resin by blending an appropriate amount of a phosphite compound and a phosphate compound, a phosphite compound can be further blended by a blending method which will be described later. As a result, a large amount of the thermal stabilizer can be blended while a decrease in the transparency, the occurrence of coloration, and a decrease in the heat resistance are avoided at the polymerization, and deterioration of the hue can be prevented.

The amount of the thermal stabilizer blended is preferably from 0.0001 to 1 part by mass, more preferably from 0.0005 to 0.5 parts by mass, still more preferably from 0.001 to 0.2 parts by mass, with respect to 100 parts by mass of the polycarbonate resin.

### <Physical Properties of Polycarbonate Resin>

Preferable physical properties of the polycarbonate resin of the present invention are described below.

### (Glass Transition Temperature)

The glass transition temperature (Tg) of the polycarbonate resin of the present invention is within the range lower than 145° C. If the glass transition temperature of the polycarbonate resin is excessively high to go beyond this range, the coloration may easily occur and the enhancement of the impact strength may become difficult. In addition, in such a case, when the shape of a mold surface is transferred to the molding in the molding process, the temperature of the mold needs to be set high. As a result, the range of selectable temperature regulating devices may be limited, or, the mold surface may be transferred less suitably.

The glass transition temperature of the polycarbonate resin of the present invention is preferably lower than 140° C., and more preferably lower than 135° C.

The glass transition temperature of the polycarbonate resin of the present invention is usually 90° C. or more, and more preferably 95° C. or more.

The polycarbonate resin of the present invention is made to have a glass transition temperature lower than 145° C. by, for example: reducing the ratio of the structural unit (1) in the polycarbonate resin; selecting an alicyclic dihydroxy compound having a low heat resistance as a dihydroxy compound for use in the production of the polycarbonate resin; or reducing the ratio of a structural unit derived from an aromatic series dihydroxy compound such as a bisphenol compound, in the polycarbonate resin.

Note that the glass transition temperature of the polycarbonate resin of the present invention is measured by a method which will be described later in examples.

### (Reduced Viscosity)

A degree of polymerization of the polycarbonate resin of the present invention is preferably 0.40 dl/g or more, more preferably 0.42 dl/g or more, and particularly preferably 0.45 dl/g or more, in terms of a reduced viscosity (hereinafter referred to simply as “the reduced viscosity”). Here, this reduced viscosity is measured using, as a solvent, a mixed solvent containing phenol and 1,1,2,2-tetrachloroethane at a mass ratio of 1:1, and the polycarbonate resin at a concentration precisely adjusted to 1.00 g/dl, at a temperature of 30.0° C.±0.1° C. However, the thermoplastic resin composition of the present invention having a reduced viscosity greater than 0.60 dl/g, or even greater than 0.85 dl/g or more may be used suitably, depending on the application of the thermoplastic resin composition. The reduced viscosity of the polycarbonate resin of the present invention is preferably 2.0 dl/g or less, more preferably 1.7 dl/g or less, and particularly preferably 1.4 dl/g or less. An excessively low reduced viscosity of the polycarbonate resin may result in a decrease in the mechanical strength, whereas an excessively high reduced viscosity of the polycarbonate resin may reduce the flowability in the molding process, deteriorate the cycle properties, increase distortion of the molding, and make the molding more liable to thermal deformation.

### [Mixing of Polycarbonate Resin]

The Component (A) of the present invention is obtained by melting and mixing a plurality of carbonate copolymers having different copolymerization ratios. A temperature for the melting and mixing, in terms of a temperature of the resin at a melt extruding outlet, is suitably from 235° C. to 245° C., and preferably from 238° C. to 242° C. Setting the temperature within this range can reduce the coloration and thermal degradation or burn marks of the polycarbonate resin, and enables production of the favorable polycarbonate resin having a high impact strength.

The range of the copolymerization ratio of each of the plurality of carbonate copolymers having different copolymerization ratios and a mixing ratio between the plurality of polycarbonate copolymers are appropriately chosen under conditions in which the copolymerization ratio of the polycarbonate resin mixture obtained through the mixing is within a predetermined range. As the copolymerization ratio of the polycarbonate resin mixture obtained through the mixing, the amount (number of moles) of the structural unit (1) accounts for 56 mol % or more, and preferably 57 mol % or more of the total amount (number of moles) of the structural unit (1) and the structural unit derived from cyclohexanedimethanol. The upper limit of the ratio is 60 mol %, and preferably 59 mol %. In other words, the amount (number of moles) of the structural unit derived from cyclohexanedimethanol accounts for 40 mol % or more, and preferably 41 mol % or more of the total amount (number of moles) described above. The upper limit of the ratio is 44 mol %, and preferably 43 mol %.

If the amount of the structural unit (1) accounts for less than 56 mol % of the total amount (number of moles) described above (i.e., if the amount of the structural unit derived from cyclohexanedimethanol accounts for more than 44 mol % of the total amount (number of moles) described above), the heat resistance may be reduced adversely. On the other hand, if the amount of the structural unit (1) accounts for more than 60 mol % of the total amount (number of moles) described above (i.e. if the amount of the structural unit derived from cyclohexanedimethanol accounts for less than 40 mol % of the total amount (number of moles) described above), the impact resistance may be reduced adversely.

In the thermoplastic resin composition, the sum of the Components (A) and (B) is 100 parts by mass, and the amount of the Component (A) blended is suitably 93 parts by mass, and preferably 94 parts by mass. If the amount of the Component (A) blended is less than 93 parts by mass, the heat resistance may be reduced adversely. On the other hand, the upper limit of the amount of the Component (A) blended is suitably 97 parts by mass, and preferably 96 parts by mass. If the amount of Component (A) blended is greater than 97 parts by mass, the impact resistance may be reduced adversely.

### [Component (B) (Butadiene-Butyl Acrylate-Methyl Methacrylate Rubber (Butadiene Rubber))]

The thermoplastic resin composition of the present invention contains the polycarbonate resin mixture that is the Component (A), and butadiene-butyl acrylate-methyl methacrylate rubber (butadiene rubber) as the Component (B). A core-shell-type graft copolymer is preferable as the butadiene rubber. The core-shell-type graft copolymer is usually formed by graft-copolymerizing a polymer component which is called a rubber component and forms a core layer, with a monomer component which is copolymerizable with the polymer component and forms a shell layer.

The core-shell-type graft copolymer may be produced by any polymerization method such as mass polymerization, solution polymerization, suspension polymerization, or emulsion polymerization. The copolymerization may be of single step grafting or multistep grafting. However, in the present invention, a commercially available butadiene rubber can be usually used as it is. Examples of the commercially available butadiene rubber include PARALOID EXL-2690 (manufactured by The Dow Chemical Company, Japan), METABLEN E-901 (manufactured by MITSUBISHI RAYON CO., LTD.), and KANEACE M-711 (manufactured by Kaneka Corporation).

The monomer component that forms the shell layer and can graft-copolymerized with the polymer component forming the core layer is (meth)acrylic ester compound.

Specific examples of the (meth)acrylic ester compound include alkyl (meth)acrylate such as methyl (meth)acrylate, ethyl (meth)acrylate, butyl (meth)acrylate, cyclohexyl (meth)acrylate, and octyl (meth)acrylate. Among them, methyl (meth)acrylate or ethyl (meth)acrylate which can be obtained relatively easily are preferable, and methyl (meth)acrylate is more preferable. Here, “(meth)acryl” is a general term for “acryl” and “methacryl.”

The core-shell-type graft copolymer includes a butadiene-styrene copolymer component in a ratio of preferably 40% by mass or more, and more preferably 60% by mass or more. The core-shell-type graft copolymer preferably includes the (meth)acrylic ester component in a ratio of 10% by mass or more.

Here, in the core-shell-type graft copolymer, the “butadiene-styrene” portion corresponds to the core layer.

One kind of the butadiene rubber comprised of the core-shell-type graft copolymer may be used alone, or two or more kinds thereof may be used in combination.

The amount of the Component (B) blended is suitably 3 parts by mass or more, preferably 3.5 parts by mass or more, and more preferably 4 parts by mass or more, with respect to 100 parts by mass of the thermoplastic resin composition described above. Blending the Component (B) in an amount of 3 parts by mass or more is preferable because it makes it easy to improve surface impact resistance and impact resistance. On the other hand, the upper limit of the amount of the Component (B) blended is suitably 7 parts by mass, preferably 6.5 parts by mass, and more preferably 6 parts by mass. It is preferable to blend the Component (B) in an amount of 7 parts by mass or less for the appearance and the heat resistance of the molding, i.e. the interior and exterior member for an automobile, according to the present invention.

### [Method for Producing Thermoplastic Resin Composition]

The thermoplastic resin composition of the present invention can be produced by melting and mixing the polycarbonate resin mixture that is the Component (A), the butadiene rubber that is the Component (B), and additives which will be described later.

Specifically, for example, the Components (A) and (B) which have been pelletized and the additives are mixed in an extruder, the mixture is extruded in the shape of a strand, and the extruded mixture is cut into pellets with a rotary cutter or other devices, thereby producing the thermoplastic resin composition of the present invention.

### <Additives>

The following additives may be added and mixed when the Components (A) and (B) are mixed together.

### (Component (C) (Dibutylhydroxytoluene))

The thermoplastic resin composition of the present invention includes dibutylhydroxytoluene as a Component (C). The inclusion of dibutylhydroxytoluene suppresses the lowering of the molecular weight of the thermoplastic resin composition during a weather resistance test, i.e., contributes to improvement of the weather resistance of the thermoplastic resin composition.

The content of the Component (C) is suitably 0.005 parts by mass or more, and preferably 0.008 parts by mass or more with respect to 100 parts by mass of the thermoplastic resin composition of the present invention. If the content of the Component (C) is less than 0.005 parts by mass, the effect of suppressing the lowering of the molecular weight during the weather resistance test may be insufficient. On the other hand, the upper limit of the content of the Component (C) is suitably 0.015 parts by mass, and preferably 0.012 parts by mass. If the content of Component (C) is greater than 0.015 parts by mass, an amount of the resin remaining adhering to the mold increases adversely.

### (Component (D) (Benzotriazole-Based Light Resistance Stabilizer))

The thermoplastic resin composition of the present invention includes a benzotriazole-based light resistance stabilizer as a Component (D). The inclusion of the benzotriazole-based light resistance stabilizer suppresses the lowering of the molecular weight of the thermoplastic resin composition during a weather resistance test.

More specific examples of the benzotriazole-based light resistance stabilizer include
2-(2′-hydroxy-3′-methyl-5′-hexylphenyl)benzotriazole,
2-(2′-hydroxy-3′-t-butyl-5′-hexylphenyl)benzotriazole,
2-(2′-hydroxy-3′,5′-di-t-butylphenyl)benzotriazole,
2-(2′-hydroxy-3′-methyl-5′-t-octylphenyl)benzotriazole,
2-(2′-hydroxy-5′-t-dodecylphenyl)benzotriazole,
2-(2′-hydroxy-3′-methyl-5′-t-dodecylphenyl)benzotriazole,
2-(2′-hydroxy-5′-t-butylphenyl)benzotriazole, and
methyl-3-(3-(2H-benzotriazole-2-yl)-5-t-butyl-4-hexylphenyl)propionate.

The content of the Component (D) is suitably 0.08 parts by mass or more, and preferably 0.09 parts by mass or more with respect to 100 parts by mass of the thermoplastic resin composition of the present invention. If the content of the Component (D) is less than 0.08 parts by mass, discoloration of a coloring agent may be prevented insufficiently. On the other hand, the upper limit of the content of the Component (D) is suitably 0.12 parts by mass, and preferably 0.11 parts by mass. If the content of Component (D) is greater than 0.12 parts by mass, an amount of the resin remaining adhering to the mold increases adversely.

### (Component (E) (Hindered Amine-Based Light Resistance Stabilizer))

The thermoplastic resin composition of the present invention includes a hindered amine-based light resistance stabilizer as a Component (E). The inclusion of the hindered amine-based light resistance stabilizer suppresses the lowering of the molecular weight of the thermoplastic resin composition during a weather resistance test.

The hindered amine-based light resistance stabilizer preferably has a structure in which nitride forms part of a cyclic structure, and more preferably has a piperidine structure. The piperidine structure specified herein may be any structure as long as it is a saturated 6-membered cyclic amine structure. The piperidine structure includes a piperidine structure of which a part is substituted by a substituent. Examples of the substituent which the piperidine structure may have include alkyl groups having 4 or less carbons. In particular, methyl groups are preferable. A compound having a plurality of piperidine structures is more preferable as the hindered amine-based light resistance stabilizer. If the hindered amine-based light resistance stabilizer has a plurality of piperidine structures, the plurality of piperidine structures are preferably linked with each other via an ester linkage. A specific example of the hindered amine-based light resistance stabilizer is represented by Formula (3) below.

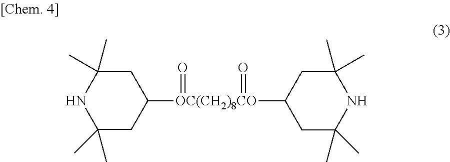

The content of the Component (E) is suitably 0.04 parts by mass or more, and preferably 0.045 parts by mass or more with respect to 100 parts by mass of the thermoplastic resin composition of the present invention. If the content of the Component (E) is less than 0.04 parts by mass, discoloration of a coloring agent may be prevented insufficient. On the other hand, the upper limit of the content of the Component (E) is suitably 0.06 parts by mass, and preferably 0.055 parts by mass. If the content of Component (E) is greater than 0.06 parts by mass, an amount of the resin remaining adhering to the mold increases adversely.

### <Blending Method>

The Components (A) to (E) may be mixed and kneaded together using, for example, a tumbler, a V-type blender, a super mixer, a Nauta mixer, a Banbury mixer, a kneading roll, or an extruder, or may be mixed by a solution blending method in which the Components which have been dissolved together in a common good solvent such as methylene chloride are mixed together. However, these are merely examples, and any commonly-used blending method may be used.

The thermoplastic resin composition obtained in the manner described above includes the components mixed together, and may be molded in a desired shape, directly or after being pelletized with an extruder, using a known molding method such as extrusion molding, injection molding, or compression molding.

### [Polycarbonate Resin Molding]

The interior and exterior member for an automobile of the present invention can be produced by molding the polycarbonate resin composition of the present invention.

In one preferred embodiment, the interior and exterior member for an automobile of the present invention is molded by injection molding.

Employing the injection molding enables the interior and exterior member for an automobile of the present invention to be molded in a complicated shape.

### EXAMPLES

Next, the present invention is described in more detail with reference to examples. Note that the following examples are not intended to limit the present invention in any way. First, an evaluation method is described.

### <Evaluation Method>

### (1) Measurement of Load Deflection Temperature

Pellets of the polycarbonate resin composition were dried at 80° C. for 6 hours, using a hot air drier. The dried pellets of the polycarbonate resin composition were supplied to an injection molding device (manufacturer: The Japan Steel Works, Ltd., product name: J75EII type), and formed into ISO specimens for mechanical property, under conditions that the resin temperature was 240° C., the molding temperature was 60° C., and the molding cycle was 40 seconds. In compliance with ISO 75, the thus obtained ISO specimens for mechanical property were measured for a load deflection temperature with a load of 1.80 MPa applied.

### (2) Measurement of Charpy Impact Strength

In compliance with ISO 179 (2000), the ISO specimens for mechanical property were subjected to the Charpy impact test of notched type. The value of the Charpy impact test increases with increase in the impact resistance of the specimen.

### (3) Overall Determination

The specimens having a load deflection temperature of 85° C. or more and a Charpy impact strength of 50 kJ/m² or more were determined to be good (indicated with a circle). The other specimens were determined to be no good (indicated with X).

### <Raw Materials>

### (Raw Materials for Polycarbonate Resin Mixture (Component (A))

ISB—isosorbide (manufacturer: Roquette Freres, product name: POLYSORB)

CHDM—cyclohexanedimethanol (manufacturer: Eastman)

DPC—diphenyl carbonate (manufacturer: Mitsubishi Chemical Corporation)

calcium acetate—(manufacturer: Wako Pure Chemical Industries, Ltd., calcium acetate monohydrate)

### <Elastic Polymer (Component (B))>

EXL2690—butadiene-butyl acrylate-methyl methacrylate rubber (manufacturer: The Dow Chemical Company, Japan, product name: PARALOID EXL2690)

### <Phenol-Based Antioxidant (Component (C))>

BHT—dibutylhydroxytoluene (manufacturer: API Corporation, product name: Yoshinox BHT)

### <Light Resistance Stabilizer>

### (Component (D))

TINUVIN329—Benzotriazole-based UVA (manufacturer: BASF, product name: TINUVIN329)

### (Component (E))

TINUVIN770DF—HALS (manufacturer: BASF, product name: TINUVIN770DF, the compound represented by Formula (3) below)

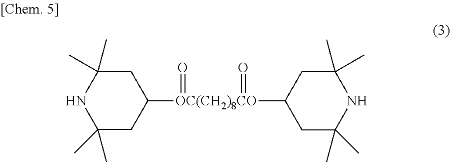

### Production Example 1

The ISB, the CHDM, the DPC distillated to have a chloride ion concentration of 10 ppb or less, and the calcium acetate monohydrate were put in a polymerization reaction device including a stirring blade and a reflux condenser controlled at 100° C., so that the content included the ISB, the CHDM, the DPC, and the calcium acetate monohydrate at a molar ratio of 0.70:0.30:1.00:1.3×10⁻⁶. After sufficient substitution with nitride, the oxygen concentration was adjusted to be within the range from 0.0005% to 0.001% by volume. Subsequently, heating was performed using a heating medium. At the time when the inner temperature reached 100° C., the stirring was started, and the content was melted and made uniform, while the inner temperature was controlled at 100° C. Thereafter, a temperature rise was started and continued for 40 minutes until the inner temperature reached 210° C. Once reached 210° C., the inner temperature was controlled and kept at this temperature. At the same time, decompression was started and continued for 90 minutes from the point in time when the inner temperature reached 210° C. until the pressure reached 13.3 kPa (absolute pressure, applicable hereinafter). The content was kept under this condition for further 60 minutes, while the pressure was kept unchanged.

By-product phenol vapor generated during the polymerization reaction was introduced into the reflux condenser in which vapor flowing into the reflux condenser and kept at a temperature of 100° C. was used as a refrigerant. A slight amount of dihydroxy compound and diester carbonate contained in the phenol vapor was returned to the polymerization reactor, and part of the phenol vapor which was not condensed was introduced and collected in a condenser in which 45° C. warm water was used as a refrigerant. The content oligomerized in this manner was once allowed to have atmospheric pressure again, and then, transferred to another polymerization reaction device including a stirring blade and a reflux condenser controlled in the same manner as above. A temperature rise and decompression were started and continued for 60 minutes until the inner temperature and the pressure reached 220° C. and 200 Pa, respectively.

Thereafter, the inner temperature and the pressure were made to reach 230° C. and 133 Pa or less, respectively, spending 20 minutes. When a predetermined stirring power was reached, the content was allowed to have atmospheric pressure again. The content in the shape of a strand was removed, and cut into pellets of carbonate copolymer with a rotary cutter.

### Production Example 2

A carbonate copolymer was produced in the same manner as in Production Example 1, except that the preparation ratio between the ISB, CHDM, DPC, and calcium acetate monohydrate was set to 0.50:0.50:1.00:1.3×10⁻⁶. The resultant carbonate copolymer was pelletized.

### Example 1

The carbonate copolymer pellets produced in Production Examples 1 and 2 were respectively blended with the polycarbonate resin composition components in ratios shown in Table 1. Each resultant blend was extruded in the shape of a strand, using a double-shaft extruder having two vent ports (manufactured by The Japan Steel Works, Ltd., product name: LABOTEX30HSS-32) such that the resin at the extruder's port had a temperature of 250° C. The extruded resin was water-cooled and solidified, and then cut into pellets with a rotary cutter. At this time, the vent ports were coupled to a vacuum pump, and control was implemented such that a pressure at the vent ports was 500 Pa. The obtained polycarbonate resin compositions were measured and evaluated for load deflection temperature (1.80 Mpa) and Charpy impact strength of notched type. Table 1 shows the results.

### Example 2, Comparative Examples 1 and 2

Polycarbonate resin compositions were produced in the same manner as in Example 1, except that the carbonate copolymer pellets produced in Production Examples 1 and 2 and the elastic polymer were blended at the ratios shown in Table 1. The resultant polycarbonate resin compositions were evaluated. Table 1 shows the results.

TABLE 1

| | | | | | | Compatative | |
|---|---|---|---|---|---|---|---|
| | | | | Examples | | Examples | |
| | | | | 1 | 2 | 1 | 2 |
| Blending | Polycorbonate Resin | Production Example 1 | (% by mass) | 48 | 47 | 23.76 | 95 |
| | Composition | (ISB:CHDM = 70:30 (molar ratio)) | | | | | |
| | | Production Example 2 | (% by mass) | 48 | 47 | 71.25 | 0 |
| | | (ISB:CHDM = 50:50 (molar ratio)) | | | | | |
| | Elastic Polymer | EXL2690 | (% by mass) | 4 | 6 | 5 | 5 |
| | Antioxidant | BHT | (% by mass) | 0.01 | 0.01 | 0.01 | 0.01 |
| | Light Resistance | Tinuvin 329 | (% by mass) | 0.1 | 0.1 | 0.1 | 0.1 |
| | Stabilizer | Tinuvin 770DF | (% by mass) | 0.05 | 0.05 | 0.05 | 0.05 |

| | | | | | | |
|---|---|---|---|---|---|---|
| Evaluation | Load Deflection Temperature (1.80 MPa) | (° C.) | 91 | 89 | 84 | 99 |
| Results | Charpy Strength of Notched Type | (kJ/m²) | 52 | 66 | 70 | 28 |

| | | | | |
|---|---|---|---|---|
| Comprehensive Evaluation | ◯ | ◯ | X | X |

1. An interior and exterior member for an automobile, the interior and exterior member comprising:
a thermoplastic resin composition including
a component (A) which is a polycarbonate resin mixture produced by melting and mixing a plurality of carbonate copolymers each including a structural unit derived from a dihydroxy compound represented by the following general formula (1) and a structural unit derived from cyclohexanedimethanol, the plurality of carbonate copolymers having different copolymerization ratios, wherein the structural unit derived from the dihydroxy compound represented by the general formula (1) is in an amount accounting for from 56 mol % to 60 mol % of a total amount of the structural unit derived from the dihydroxy compound represented by the general formula (1) and the structural unit derived from cyclohexanedimethanol, 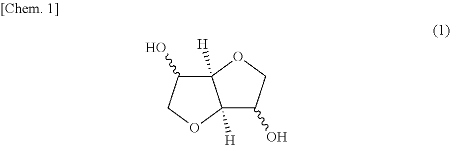
a component (B) which is butadiene-butyl acrylatemethyl-methacrylate rubber,
a component (C) which is dibutylhydroxytoluene,
a component (D) which is a benzotriazole-based light resistance stabilizer, and
a component (E) which is a hindered amine-based light resistance stabilizer, wherein
the component (C) is in an amount accounting for from 0.005 parts to 0.015 parts by mass, the component (D) is an amount accounting for from 0.08 parts to 0.12 parts by mass, and the component (E) is in an amount accounting for from 0.04 part to 0.06 parts by mass, respectively, with respect to 100 parts by mass of a total amount of the components (A) and (B), and the component (A) is in an amount accounting for from 93% to 97% by mass of the total amount of the components (A) and (B).

2. The interior and exterior member of claim 1, wherein
the hindered amine-based light resistance stabilizer has a piperidine structure.

3. The interior and exterior member of claim 1, wherein
the hindered amine-based light resistance stabilizer has a plurality of piperidine structures.

4. The interior and exterior member of claim 3, wherein
the plurality of piperidine structures of the hindered amine-based light resistance stabilizer are linked with each other via an ester linkage.

5. The interior and exterior member of claim 1, wherein
the interior and exterior member is produced by injection molding.

6. The interior and exterior member of claim 2, wherein
the interior and exterior member is produced by injection molding.

7. The interior and exterior member of claim 3, wherein
the interior and exterior member is produced by injection molding.

8. The interior and exterior member of claim 3, wherein
the interior and exterior member is produced by injection molding.

9. The interior and exterior member of claim 4, wherein
the interior and exterior member is produced by injection molding.
